(19) United States
(12) Patent Application Publication
(10) Pub. No.: US 2012/0189730 A1
(43) Pub. Date: Jul. 26, 2012

(54) FINCH FOOD FORMULATION

(75) Inventor: Mario Olmos, Fort Worth, TX (US)

(73) Assignee: CENTRAL GARDEN & PET COMPANY, Walnut Creek, CA (US)

(21) Appl. No.: 13/355,238

(22) Filed: Jan. 20, 2012

Related U.S. Application Data
(60) Provisional application No. 61/434,706, filed on Jan. 20, 2011.

(51) Int. Cl. A23K 1/18

(52) U.S. Cl. 426/1

(57) ABSTRACT

A finch food formulation comprised of thistle, red millet, fine sunflower chips, and fine peanut hearts attracts more colorful finches than other commercial formulations typically consisting of thistle/nyjer seed alone or a thistle/sunflower chip blend. This finch food formulation attracts more individual bird species than commercial formulations typically consisting of thistle/nyjer seed alone or a thistle/sunflower chip blend. This finch food formulation also attracts twice as many birds in general (by total number) than commercial formulations typically consisting of thistle/nyjer seed alone or a thistle/sunflower chip blend.

### FIELD OF THE INVENTION

The disclosure relates generally to bird feed, and more specifically, to a finch food formulation that attracts more finches.

### BACKGROUND

Bird watchers want to provide food to attract birds that have desirable qualities and are interesting to observe. However, sometimes the food placed in a backyard feeder, for example, tends to attract less desirable birds and may even deter other more colorful birds from visiting the backyard feeder. Further, these less desirable birds may consume the food supply, leaving little for other birds to feed.

### SUMMARY

Embodiments of the present disclosure generally provide a finch food formulation comprising thistle, red millet, fine sunflower chips, and fine peanut hearts, wherein the formulation attracts twice as many finches than a thistle/nyjer blend or a thistle/sunflower chip blend. Thistle may comprise approximately 55-65% of the formulation. Red miller may comprise approximately 15-25% of the formulation. Fine sunflower chips may comprise approximately 10-20% of the formulation. Fine peanut hearts may comprise approximately 1-10% of the formulation. The formulation also may attract more colorful finches than the thistle/nyjer blend or the thistle/sunflower chip blend.

Other embodiments of the present disclosure may provide a finch food formulation comprising thistle, red millet, fine sunflower chips, and fine peanut hearts, wherein the formulation attracts more colorful finches than a thistle/nyjer blend or a thistle/sunflower chip blend. Thistle may comprise approximately 60% of the formulation. Red millet may comprise approximately 20% of the formulation. Fine sunflower chips may comprise approximately 15% of the formulation. Fine peanut hearts may comprise approximately 5% of the formulation. The formulation also may attract twice as many finches than the thistle/nyjer blend or the thistle/sunflower chip blend.

Additional embodiments of the present disclosure may provide a finch food formulation comprising 55-65% thistle, 15-25% red millet, 10-20% fine sunflower chips, and 1-10% fine peanut hearts. The formulation may attract twice as many finches than a thistle/nyjer blend or a thistle/sunflower chip blend. The formulation also may attract more colorful finches than a thistle/nyjer blend or a thistle/sunflower chip blend.

### BRIEF DESCRIPTION OF THE DRAWINGS

For a more complete understanding of this disclosure and its features, reference is now made to the following description, taken in conjunction with the accompanying drawing, in which:

The FIGURE depicts an embodiment of the testing area used to evaluate the new finch food formulation according to an embodiment of the present disclosure.

### DETAILED DESCRIPTION

The present disclosure provides for a finch food formulation to attract finches that is more effective than other commercial formulations consisting of thistle/nyjer seed alone or a thistle/sunflower chip blend. The finch food formulation according to embodiments of the present disclosure may be comprised of thistle, red millet, fine sunflower chips, and fine peanut hearts, as will be described in more detail below.

Several trials were conducted to evaluate the performance of this new finch food formulation formed according to an embodiment of the present disclosure in comparison to other presently available commercial formulations of thistle/sunflower chips and thistle/nyjer seed alone. More specifically, a series of side-by-side field-testing trials were conducted in the summer and early fall months.

Data related to the trials were generated in four different regions of the United States—Ohio, Oregon, Wisconsin, and New Jersey. These regions were selected as they have remarkable differences in vegetation, sound, topography, human contact, water access, and disturbance from other animals and natural predators.

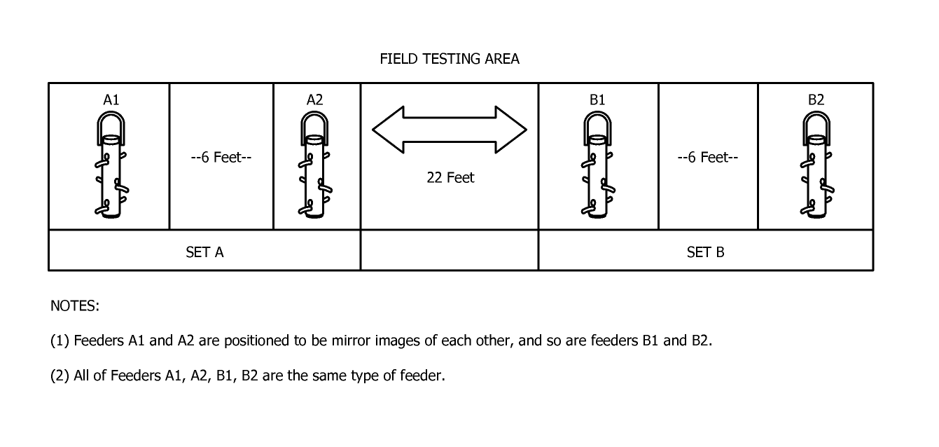

Each testing area within a region was divided into two sets—Set A and Set B. Each testing area utilized the same testing layout as generally depicted in the FIGURE. 20 feet separated Set A from Set B in each of the testing areas. There were two feeders positioned in each Set, and these feeders were spaced 6 feet apart in a parallel configuration. The feeders were positioned to be mirror images of each other, subject to the relevant environmental factors.

Each of the testing areas also utilized different types of feeders, with each Set in the testing area having two feeders. One testing area within a region utilized only sock feeders. A second testing area within the region utilized only thistle/nyjer seed feeders. The third testing area only used tube feeders. The data collected from the different feeders for the various testing areas confirm that the types of feeders utilized in the testing area did not affect the benefits and attractiveness of the new finch food formulation according to an embodiment of the present disclosure.

Three different formulations were used for the testing trials. The first formulation was comprised of a blend of thistle/nyjer (40%) and sunflower chips (60%), a blend commonly used in commercial finch food formulations. The second formulation was comprised of a thistle/nyjer seed blend. The final formulation was the new finch food formulation according to an embodiment of the present disclosure comprised of thistle, red millet, fine sunflower chips and fine peanut hearts. This finch food formulation may be generally comprised of 55-65% thistle (more preferably approximately 60%), 15-25% red millet (more preferably approximately 20%), 10-20% fine sunflower chips (more preferably approximately 15%), and 1-10% fine peanut hearts (more preferably approximately 5%).

The three formulations used in the various testing areas were rotated and evaluated for periods of four days at each Set within a given testing area. In the initial set-up, each feeder was completely emptied of all contents and re-filled with the formulation to be tested in that feeder. For each subsequent day of observation with respect to a given formulation, the feeders were filled with the formulation to be tested. At the end of each four-day trial, all feeders were emptied of their contents.

Data at all sites was collected using a snapshot observation protocol. This protocol typically proceeds as follows: observe and record, wait five minutes, and repeat over a period of approximately 30 minutes. At the conclusion of a 30-minute period, there is a 15-minute break before repeating the same protocol for another 30-minute period.

Based on 523 experiments, birds preferred the new finch food formulation according to an embodiment of the present disclosure relative to thistle/nyjer by a margin of 355 to 168. Over 46 trials, birds preferred the new finch food formulation according to an embodiment of the present disclosure (60% thistle, 20% red millet, 15% fine sunflower chips and 5% fine peanut hearts) relative to thistle/nyjer by a margin of 41 to 5. In terms of total number of birds, birds were more attracted to the new finch food formulation according to an embodiment of the present disclosure relative to thistle/nyjer by a margin of 1638 to 1194.

Based on 387 experiments, birds preferred the new finch food formulation according to an embodiment of the present disclosure relative to the thistle/sunflower chip blend by a margin of 279 to 108. Over 39 trials, birds preferred the new finch food formulation according to an embodiment of the present disclosure relative to the thistle/sunflower chip blend by a margin of 38 to 1. In terms of total number of birds, birds were more attracted to the new finch food formulation according to an embodiment of the present disclosure relative to the thistle/sunflower chip blend by a margin of 963 to 642.

The new finch food formulation according to an embodiment of the present disclosure was found to attract more (in terms of number) colorful finches than thistle/nyjer seed alone or a thistle/sunflower chip blend. This new finch food formulation also was found to attract more individual bird species than these commercially available finch seed formulations. This new finch food formulation also was found to attract twice as many birds in general (by total number) than these commercially available finch seed formulations.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A finch food formulation comprising:
thistle, red millet, fine sunflower chips, and fine peanut hearts,
wherein the formulation attracts twice as many finches than a thistle/nyjer blend or a thistle/sunflower chip blend.

2. The formulation of claim 1 wherein thistle comprises approximately 55-65% of the formulation.

3. The formulation of claim 1 wherein red millet comprises approximately 15-25% of the formulation.

4. The formulation of claim 1 wherein fine sunflower chips comprise approximately 10-20% of the formulation.

5. The formulation of claim 1 wherein fine peanut hearts comprise approximately 1-10% of the formulation.

6. The formulation of claim 1 wherein the formulation attracts more colorful finches than the thistle/nyjer blend or the thistle/sunflower chip blend.

7. A finch food formulation comprising:
thistle, red millet, fine sunflower chips, and fine peanut hearts,
wherein the formulation attracts more colorful finches than a thistle/nyjer blend or a thistle/sunflower chip blend.

8. The finch food formulation of claim 7 wherein thistle comprises approximately 60% of the formulation.

9. The finch food formulation of claim 7 wherein red millet comprises approximately 20% of the formulation.

10. The finch food formulation of claim 7 wherein fine sunflower chips comprise approximately 15% of the formulation.

11. The finch food formulation of claim 7 wherein fine peanut hearts comprise approximately 5% of the formulation.

12. The finch food formulation of claim 7 wherein the formulation attracts twice as many finches than the thistle/nyjer blend or the thistle/sunflower chip blend.

13. A finch food formulation comprising:
55-65% thistle, 15-25% red millet, 10-20% fine sunflower chips, and 1-10% fine peanut hearts.

14. The finch food formulation of claim 13 wherein the formulation attracts twice as many finches than a thistle/nyjer blend or a thistle/sunflower chip blend.

15. The finch food formulation of claim 13 wherein the formulation attracts more colorful finches than a thistle/nyjer blend or a thistle/sunflower chip blend.
